(19) United States
(12) Patent Application Publication
(10) Pub. No.: US 2021/0214145 A1
(43) Pub. Date: Jul. 15, 2021

(54) PACKAGE CUSHIONING MATERIAL AND METHOD FOR FABRICATING THE SAME

(71) Applicant: Dongguan Wangquan Paper Products Co., Ltd., Guangdong (CN)

(72) Inventor: SHENG-HSI KUO, Guangdong (CN)

(73) Assignee: Dongguan Wangquan Paper Products Co., Ltd., Guangdong (CN)

(21) Appl. No.: 16/836,960

(22) Filed: Apr. 1, 2020

(30) Foreign Application Priority Data
Jan. 15, 2020 (CN) 202010043829.5

(51) Int. Cl. B65D 81/113; B65D 5/50

(52) U.S. Cl. CPC B65D 81/113; B65D 2581/053; B65D 5/5073; B65D 5/5076

(57) ABSTRACT

The present application relates to the filed packages, and in particular, to a package cushioning material and the method for fabricating the same. The technical solution of the package cushioning material mainly lies in comprising a main body protection portion and a side protection portion, both of the main body protection portion and the side protection portion assuming a U-shaped tube shape, the main body protection portion being connected with the side protection portion via a paper board in a fixed way.

### CROSS-REFERENCE TO RELATED APPLICATION

This application claims the priority benefit of China application serial no. 202010043829.5, filed on Jan. 15, 2020. The entirety of the above-mentioned patent application is hereby incorporated by reference herein and made a part of this specification.

### FIELD OF THE INVENTION

The present application relates to the field of packages, and in particular, to a package cushioning material and a method for fabricating the package cushioning material.

### DESCRIPTION OF RELATED ART

A package cushioning material is required during the transportation of necessary daily articles such as electronic products, glass wares, or the like, mainly serving the function of protecting the articles wrapped therein from some physical damages that mainly include falling, impacting, bumping, compressing, etc.

At present, one kind of package cushioning material is a foamed material obtained from the foaming of ethylene-vinyl acetate (EVA). By making the foamed material into different shapes and wrapping around the products, such kind of the material can well protect the products from physical damages. However, EVA belongs to plastic materials and is not degradable, imposing relatively high contamination to the environment. Another kind of the package cushioning material is a paper-made package material, which can be easily recycled, with a tendency to be degradable and friendly to environment. The package cushioning material made from paper materials can meet the requirement for cushioning the articles to be protected well.

There are many kinds of paper-made package cushioning materials available on the market. In particular, U.S. Pat. No. 7,754,310B2 disclosed a package cushioning material, in which, by referring to FIG. 1, the main body protection portion 1 of the cushioning material is a U-shaped sleeve, with a concave groove 5 being formed at the center of each of the pair of outer walls of the main body protection portion 1 along the length direction, and a plug 2 provided at each end of the main body protection portion 1 for preventing the packaged articles from slipping off. The concave groove 5 is of a subtle design that is capable of distributing the pressure and substantially springing back upon the releasing of the pressure. Therefore, having a good performance during a general pressure test.

However, such a package cushioning material does not perform well in an anti-fall test, since the plugs at two ends tends to slip off. When being dropped down, the package cushioning material with products packaged therein will suffer a substantial impulse, such that the plug 2 can not well protect the product due to the impulse. For the purpose of addressing the robustness, a relatively large amount of adhesive will be coated at the joint of the plug 2 with the package cushioning material, which, however, does not provide desirable effect since the phenomenon of slipping off remains during the anti-fall test. Another method for addressing the robustness is by changing the shape and structure of the plug 2, which will make the process complicated, thus requiring higher cost of man power cost and higher cost of equipment.

Regarding the above deficiencies presented in prior art, there is an urgent need for a package cushioning material for addressing the same issues.

### BRIEF SUMMARY OF THE INVENTION

Regarding the deficiencies presented in the prior art, one object of the present application is to provide a package cushioning material having the beneficial effects of low production cost, good anti-compressing performance and anti-fall performance.

The above object of the present application is achieved by the following technical solution: a package cushioning material comprising a main body protection portion and a side protection portion, both of the main body protection portion and the side protection portion assuming a U-shaped tube shape, the main body protection portion being connected with the side protection portion via a paper board in a fixed way.

By adopting the above technical solution, both of the main body protection portion and the side protection assumes a U-shaped tube shape, and thus can be processed by the same process, reducing the processing steps for fabricating the whole package cushioning material, decreasing the types of the equipment as used, and in turn reducing the cost. In comparison with a plug used in the prior art, the side protection portion having a U-shaped tube shape has better cushioning and protecting effect, improving the anti-compressing performance of the package cushioning material. After integrally connecting the main body protection portion with the side protection portion, the side protection portion tends not to separate from the main body protection portion when being dropped down, thereby improving the anti-fall performance of the package cushioning performance.

In a preferred embodiment of the present application, the side protection portion includes two side protection portions, which are separately provided at two ends of the main body protection portion, so that the package cushioning material assuming a U shape as a whole.

By adopting the above technical solution, the U-shaped package cushioning material enables protecting two corners and one edge of a square product to be packaged.

In a further preferred embodiment of the present application, the side protection portion includes one side protection portion, which is provided at one end of the main body protection portion, so that the package cushioning material assumes an L shape.

By adopting the above technical solution, the L-shaped package cushioning material enables protecting one corner of a square product, and four L-shaped package cushioning materials enables packaging the whole square product.

In a further preferred embodiment of the present application, a concave groove is provided near the center of outer side walls of the main body protection portion along the length direction of the main body protection portion.

By adopting the above technical solution, the provided concave groove can enhance the anti-compressing effect of the main body protection portion.

In a further preferred embodiment of the present application, a concave groove is provided near the center of an outer side wall of the side protection portion along the length direction of the side protection portion.

By adopting the above technical solution, the provided concave groove can enhance the anti-compressing effect of the side protection portion.

In a further preferred embodiment of the present application, the concave groove can be an arc groove, a V-shaped groove, an oblong groove, a trapezoidal groove, a step-shaped groove or a chute-shaped groove.

By adopting the above technical solution, the grooves having the above mentioned shapes can enhance the anti-compressing effect of the protection portions.

In a preferred embodiment of the present application, the main body protection portion is provided with an insertion tube.

By adopting the above technical solution, the insertion tube can enhance the anti-compressing effect of the main body protection portion.

In a further preferred embodiment of the present application, the side protection portion is provided with an insertion tube.

By adopting the above technical solution, the insertion tube can enhance the anti-compressing effect of the side protection portion.

In a further preferred embodiment of the present application, a side wall of the main body protection portion is fixedly connected with a side wall of the side protection portion via an environment friendly adhesive tape.

By adopting the above technical solution, the environment friendly adhesive tape is a kind of degradable environment-friendly material, which, on one hand, enables firmly adhering the main body protection portion to side protection portion, and on the other hand, renders the whole package cushioning material more friendly to the environment.

Regarding the deficiencies present in the present application, another object of the present application is to provide a method for fabricating a package cushioning material requiring low production cost, and producing package cushioning materials with good anti-compressing performance and anti-fall performance.

The above object of the present application is achieved by the following technical solution: a method for fabricating a package cushioning material including the steps of:

Step 1: calculating a length a of a main body protection portion, a length b of a side protection portion, a length c of a paper board according to a product to be packaged, and calculating and determining positions on the paper board for connecting the main body protection portion with the side protection portion;

Step 2: fabricating a long paper barrel;

Step 3: cutting the long paper barrel into a short paper barrel having a length a and a short paper barrel having a length b;

Step 4: processing the short paper barrel having the length a into the main body protection portion having a U-shaped tube shape, and processing the short paper barrel having the length b into a side protection portion having a U-shaped tube shape;

Step 5: fabricating a big paper board;

Step 6: cutting the big paper board into a shape of the paper board having a length c and a width equal to that of the main body protection portion;

Step 7: making a crease on the paper board, and adhering the main body protection portion and the side protection portion onto corresponding positions on the paper board;

Step 8: folding the paper board along the crease, so that the side protection portion is folded to an end of the main body protection portion;

Step 9: fixedly connecting the main body protection portion with the side protection portion with an environment friendly adhesive tape.

By adopting the above technical solution, a plug used in the prior art is not needed in such a fabricating method. Actually, for a better filling effect, plugs having various shapes have to be produced by complex processes, requiring higher cost of equipment and higher cost of man power. In particular, the processing step of inserting the plug into the main body protection portion is difficult to be automatically achieved by an equipment, and thus requires higher cost of man power. By using a side protection portion to protect the sides of a product in place of a plug, much of the cost can be saved during the process since the side protection portions can be processed by the equipment used for processing the main protection portion. Therefore, the equipment cost required for producing a plug can be saved, and the cost of man power for inserting the plug into the main protection portion can be reduced. The processing steps 7, 8, and 9 can be easily and automatically operated, without the need of human operators.

In summary, the present application can achieve at least one of the following beneficial technical effects:

Firstly, lower production cost;

Secondly, good anti-compressing effect; and

Thirdly, good anti-fall effect.

### BRIEF DESCRIPTION OF THE DRAWINGS

FIG. 1 is the schematic overall structural diagram of a package cushioning material in a prior art;

FIG. 2 is the schematic overall structural diagram of Embodiment 1;

FIG. 3 is the side view of Embodiment 1;

FIG. 4 is the sectional view taken along the A-A face in FIG. 3;

FIG. 5 is the schematic overall structural diagram of Embodiment 2;

FIG. 6 is the sectional view of the main body protection portion of Embodiment 2;

FIG. 7 is the sectional view of the main body protection portion of Embodiment 3;

FIG. 8 is the sectional view of the main body protection portion of Embodiment 4;

FIG. 9 is the schematic overall structural diagram of Embodiment 5;

FIG. 10 is the schematic overall structural diagram of Embodiment 6;

FIG. 11 is part of the fabrication process diagram of Embodiment 1;

FIG. 12 is part of the fabrication process diagram of Embodiment 2.

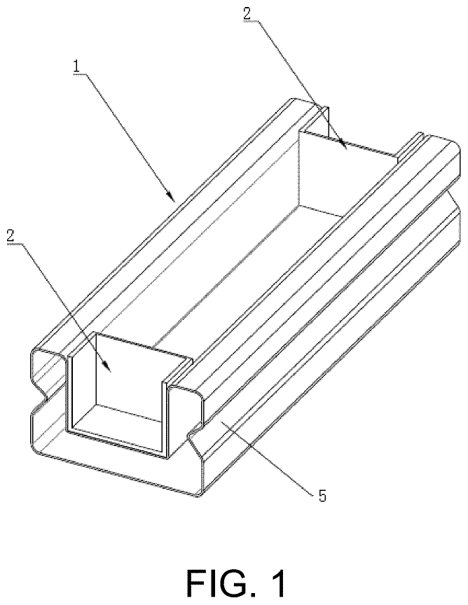

### DETAILED DESCRIPTION

The present application will be further described in detail below in connection with Drawings and Embodiments.

### Embodiment 1

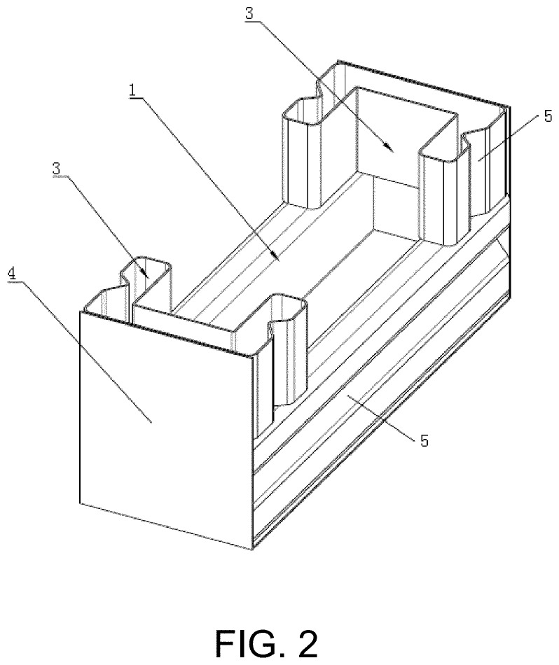

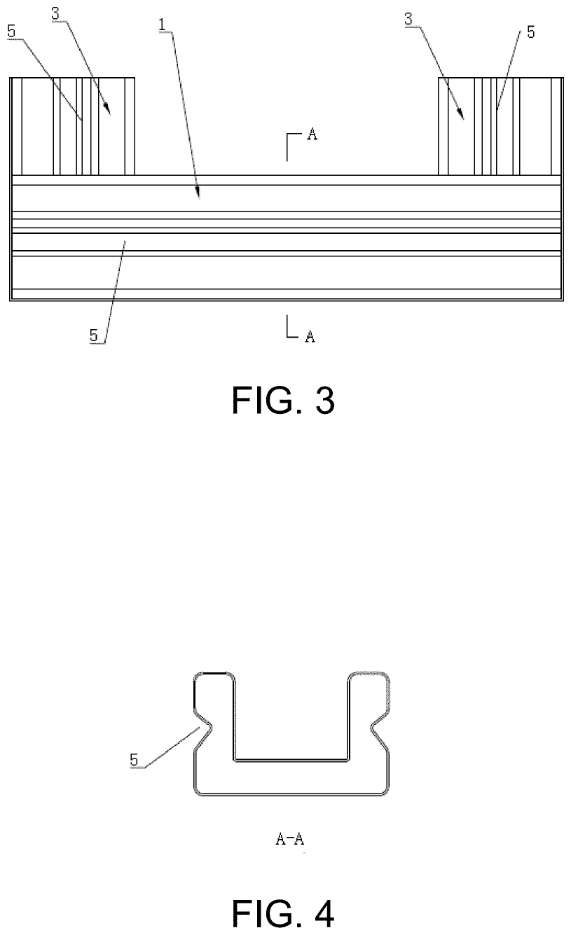

Referring to FIG. 2, FIG. 3 and FIG. 4, a package cushioning material includes a main body protection portion 1 and side protection portion 3, both of which have U-shaped tube shape, with the main body protection portion 1 and side protection portion 3 being connected with each other via a paper board 4 in a fixed manner. In particular, the left and right side walls of the main body protection portion 1 and those of the side protection portion 3 are fixedly connected with each other via an environment friendly adhesive tape, which is not shown in the figure. In this embodiment, there are two side protection portions 3 separately disposed at the two ends of the main body protection portion 1, so that the package cushioning material assumes a U-shape as a whole. A concave groove 5 is disposed near the center of the outer side wall of the main body protection portion 1, along the length direction of the main body protection portion 1. A concave groove 5 is disposed near the center of the outer side wall of the side protection portion 1, along the length direction of the side protection portion 3. In this embodiment, both of the concave grooves 5 provided on the main body protection portion 1 and the side protection portion 3 are v-shaped grooves.

Embodiment 1 is fabricated by the method including:

Step 1: calculating the length a of the main body protection portion 1, the length b of the side protection portion 3, the length c of the paper board 4 according to the products to be packaged, and calculating and determining the position on the paper board 4 for connecting the main body protection portion 1 with the side protection portion 3;

Step 2: fabricating a long paper barrel, the particular process of which is a conventional technology, and thus is omitted here;

Step 3: cutting the long paper barrel into a short paper barrel having a length a and a short paper barrel having a length b, by referring to FIG. 11;

Step 4: processing the short paper barrel having the length a into the main body protection portion 1 having the U-shaped tube shape, and processing the short paper barrel having the length b into the side protection portion 3 having the U-shaped tube shape, in particular, by using a special compressing and folding equipment that may be the same as those used for fabricating a package cushioning material in the prior art;

Step 5: fabricating a big paper board 4. In this embodiment, it is done by the method for fabricating a corrugated paper board 4, and the obtained big paper board belongs to one kind of the corrugated paper board. In other embodiments, the paper board 4 is other type of paper boards 4. All of the paper boards 4 for connecting the side protection portion 3 and the main body protection portion 1 belong to the technical solutions claimed by the present application;

Step 6: cutting the big paper board 4 into the shape of a paper board 4 having the length c and a width equal to that of the main body protection portion 1, which can be understood in connection with FIG. 11 for particular shape;

Step 7: making a crease at the processing position of the paper board 4, and adhering the main body protection portion 1 and the side protection portion 3 onto corresponding positions on the paper board 4;

Step 8: folding the paper board 4 along the creases, so that the side protection portion 3 is folded to the ends of the main body protection portion to form the shape shown in FIG. 2;

Step 9: fixedly connecting the main body protection portion 1 with the side protection portion 3 with an environment friendly adhesive tape.

### Embodiment 2

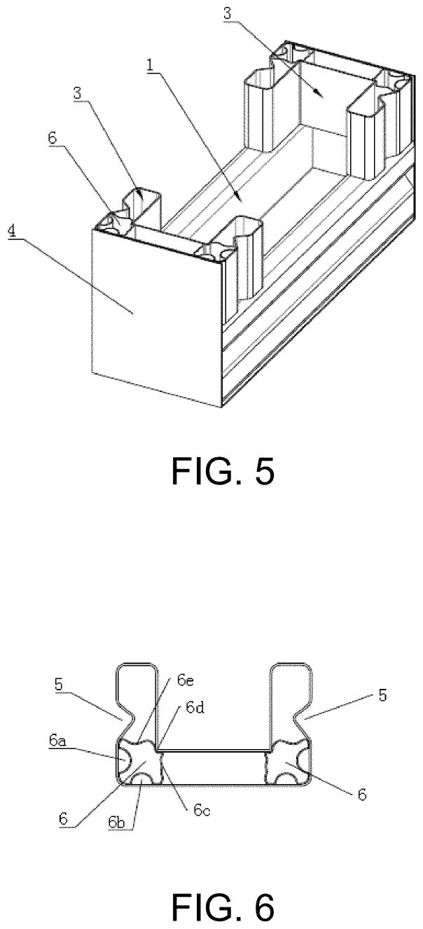

Referring to FIG. 5 and FIG. 6, this embodiment has a shape and structure substantially the same as those of Embodiment 2, except in that, insertion tubes 6 are provided in each of the main protection portion 1 and the side protection portion 3, serving the function of enhancing the overall structure, in comparison with Embodiment 1. It is to be noted that, the providing of the insertion tube 6 can be changed by those skilled in the art based on actual needs, for example, the insertion tube 6 being provided only in the main body protection portion 1, only in the side protection portions 3, or only in one of the side protection portions 3. All the technical solutions obtained by simply changing the way of providing these insertion tubes 6 belong to the technical solutions claimed by the present application. In this embodiment, the insertion tube 6 has a sectional shape including a first arc groove 6a, a second arc groove 6b, a first corrugated section 6c, a second corrugated section 6e, and a recessed portion 6d matching the main body protection portion 1 or the side protection portion 3, as shown in the figures.

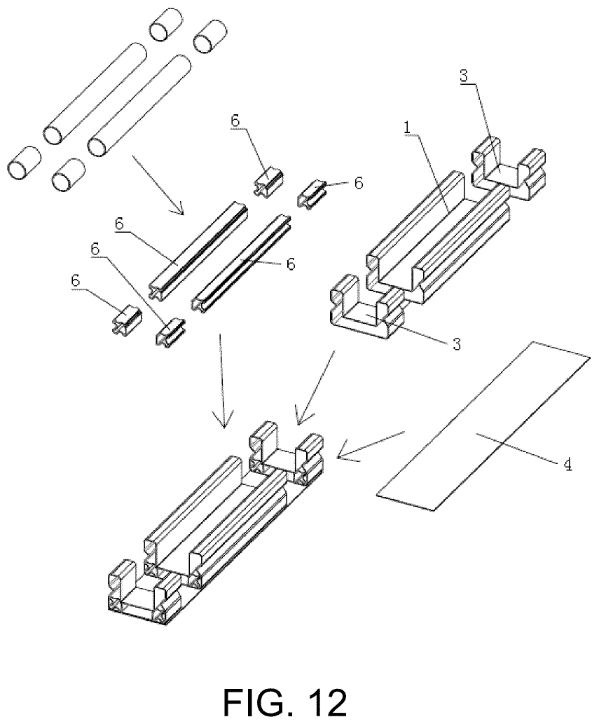

Referring to FIG. 12, the fabricating method in this embodiment is substantially the same as that in Embodiment 1, except for two steps.

In particular, one additional step is the step for processing the insertion tube 6, which particularly includes:

S1: fabricating a long small paper barrel;

S2: cutting the long small paper barrel into short small paper barrel having a length a and a short small paper barrel having a length b;

S3: folding the short small paper barrels having the lengths of a and b into the shape of the insertion tube 6, which can be achieved by the same process as those for folding the main body protection portion 1 and the side protection portion 3, except for changing the dies for folding to realize the production of the insertion tube 6.

Another additional step includes inserting the insertion tube 6 into the main body protection portion 1 and the side protection portion 3, in which a glue can be coated around the circumference of the insertion tube 6, and the insertion tubes 6 having corresponding lengths can be respectively inserted into corresponding positions in the main body protection portion 1 and the side protection portion 3 manually or automatically.

### Embodiment 3

Referring to FIG. 7, this embodiment has a shape and structure substantially the same as those in Embodiment 2, except in that the insertion tube 6 has a slightly different shape. In connection with FIG. 6, the particular difference lies in that, the first corrugated section 6c is changed to a third arc groove 6f. It is to be understood by those skilled in the art that, the function of the insertion tube 6 is to increase the structural strength of the main body protection portion 1 and the side protection portion 3, and the shape and structure of the insertion tube 6 can not only be those exemplified in the embodiments, but also be others, in which all the shapes and structures that can enhance the structural strength of the main body protection portion 1 and the side protection portion 3 belong to the technical solutions claimed by the present application.

### Embodiment 4

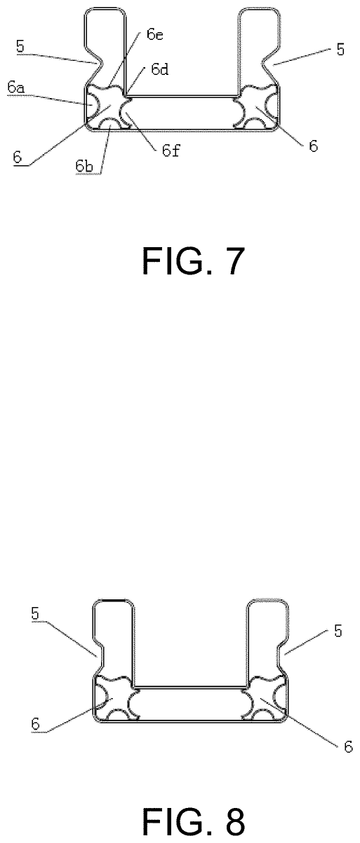

Referring to FIG. 8, this embodiment has a shape and structure substantially the same as those in Embodiment 3, except in that the concave groove 5 is a trapezoidal-shaped groove. In other embodiments, the concave groove 5 can be an arc groove, an oblong groove, a step-shaped groove, a chute-shaped groove, or other kinds of concave groove 5. The technical solutions obtained by simply changing the shape and structure of the concave groove 5 belong to the technical solutions claimed by the present application.

### Embodiment 5

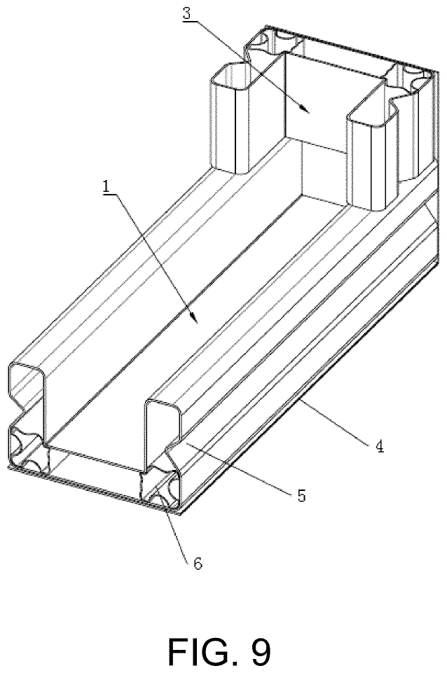

Referring to FIG. 9, this embodiment has a shape and structure substantially the same as those in Embodiment 2, except in that only one side protection portion 3 is provided in this embodiment. The side protection portion 3 is provided at one end of the main body protection portion 1, so that the package cushioning material assumes an L-shape. It is to be understood by those skilled in the art that, the length of the side protection portion 3 can be adjusted based on actual needs.

### Embodiment 6

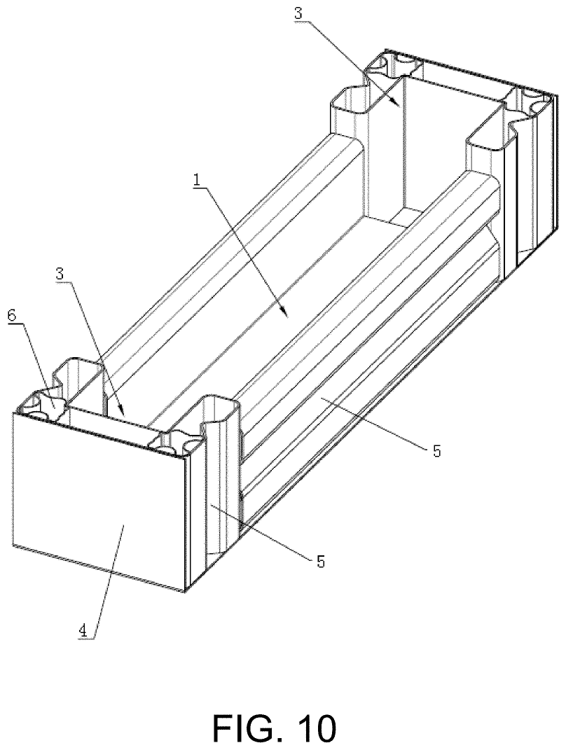

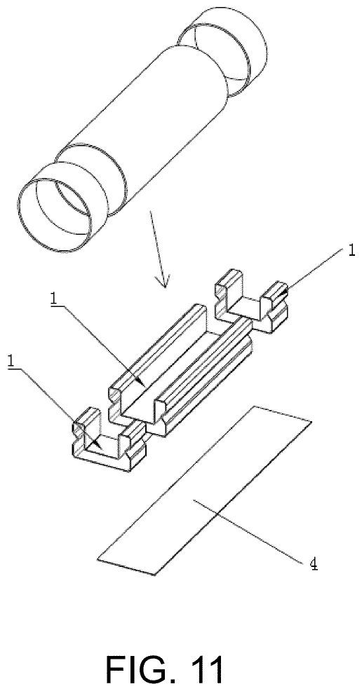

Referring to FIG. 10, this embodiment has a shape and structure substantially the same as those in Embodiment 2, except in that, creases are provided at different positions on the paper board connecting the main body protection portion with the side protection portion, so that the tow side protection portions are not above the main body protection portion, but leaning against the two ends of the main body protection portion in the processed package cushioning material.

Anti-fall test is performed for the package cushioning material obtained in Embodiments 1-6 and the package cushioning material mentioned in the background as a comparison example. It was found that, in a 1000-time 2 m anti-fall test, slipping off of the plugs occurred about 60-90 times for the comparison example, such that the products were damaged, and in a 1000-time 1 m anti-fall test, slipping off of the plugs occurred about 30-60 times for the comparison example, such that the products were damaged. In comparison, the phenomena of being unable to protect the packaged products did not occur for various embodiments according to the present application. Such tests show that the package cushioning material according to the present application has better anti-fall performance.

It is to be noted that, the main body protection portion and the side protection portion in various embodiments adopt the same U-shaped tube shape and have the advantage of convenient production. However, it will be understood by those skilled in the art that, the main body protection portion and the side protection portion can be made into other shapes. What are provided above are only the preferred implementations of the present application, and the present application are not intended to be limited thereto, on the contrary, all the technical solutions sharing the concepts of the present application fall within the scope of the present application. It is to be further noted that, several improvements and modifications made by those skilled in the art without departing from the principle of the present application should be considered as falling in the scope of the present application.

What is claimed is:

1. A package cushioning material comprising a main body protection portion and a side protection portion, both of the main body protection portion and the side protection portion assuming a U-shaped tube shape, the main body protection portion being connected with the side protection portion via a paper board in a fixed way.

2. The package cushioning material according to claim 1, wherein the side protection portion comprises two side protection portions, which are separately provided at two ends of the main body protection portion, so that the package cushioning material assuming a U shape as a whole.

3. The package cushioning material according to claim 1, wherein the side protection portion comprises one side protection portion, which is provided at one end of the main body protection portion, so that the package cushioning material assumes an L shape.

4. The package cushioning material according to claim 1, wherein a concave groove is provided near the center of outer side walls of the main body protection portion along the length direction of the main body protection portion.

5. The package cushioning material according to claim 1, wherein a concave groove is provided near the center of an outer side wall of the side protection portion along the length direction of the side protection portion.

6. The package cushioning material according to claim 4, wherein the concave groove is selected from the group consisting of an arc groove, a V-shaped groove, an oblong groove, a trapezoidal groove, a step-shaped groove or a chute-shaped groove.

7. The package cushioning material according to claim 1, wherein the main body protection portion is provided with an insertion tube.

8. The package cushioning material according to claim 1, wherein the side protection portion is provided with an insertion tube.

9. The package cushioning material according to claim 1, wherein a side wall of the main body protection portion is fixedly connected with a side wall of the side protection portion via an environment friendly adhesive tape.

10. A method for fabricating a package cushioning material comprising the steps of:
Step 1: calculating a length a of a main body protection portion, a length b of a side protection portion, and a length c of a paper board according to a product to be packaged, and calculating and determining positions on the paper board for connecting the main body protection portion with the side protection portion;
Step 2: fabricating a long paper barrel;
Step 3: cutting the long paper barrel into a short paper barrel having the length a and a short paper barrel having the length b;
Step 4: processing the short paper barrel having the length a into the main body protection portion having a U-shaped tube shape, and processing the short paper barrel having the length b into a side protection portion having a U-shaped tube shape;
Step 5: fabricating a big paper board;
Step 6: cutting the big paper board into a shape of the paper board having the length c and a width equal to that of the main body protection portion;
Step 7: making a crease on the paper board, and adhering the main body protection portion and the side protection portion onto corresponding positions on the paper board;
Step 8: folding the paper board along the crease, so that the side protection portion is folded to an end of the main body protection portion; and
Step 9: fixedly connecting the main body protection portion with the side protection portion with an environment friendly adhesive tape.
